(19) United States
(12) Patent Application Publication
(10) Pub. No.: US 2014/0330814 A1
(43) Pub. Date: Nov. 6, 2014

(54) METHOD, CLIENT OF RETRIEVING INFORMATION AND COMPUTER STORAGE MEDIUM

(71) Applicant: Tencent Technology (Shenzhen) Company Limited, Shenzhen City (CN)

(72) Inventor: CHENG-JUN LI, Shenzhen City (CN)

(73) Assignee: Tencent Technology (Shenzhen) Company Limited, Shenzhen City (CN)

(21) Appl. No.: 14/254,882

(22) Filed: Apr. 16, 2014

Related U.S. Application Data
(63) Continuation of application No. PCT/CN2014/070292, filed on Jan. 8, 2014.

(30) Foreign Application Priority Data
May 3, 2013 (CN) 201310162560.2

(51) Int. Cl. G06F 17/30

(52) U.S. Cl. CPC G06F 17/30554
USPC 707/722

(57) ABSTRACT

This document publishes a method and an apparatus of retrieving information. In one embodiment, the method includes the following steps: receiving position information of interest points selected by a user in a panoramic image; extracting boundaries of a searching object in the panoramic image according to the position information; extracting an image of the searching object from the panoramic image; sending the image of the searching object to a backend server for searching; receiving a searching result about the searching object from the backend server; extracting relevant information about the searching object from the searching result; and displaying the relevant information. The method mines the potential information hidden underneath the panoramic images. Accordingly, latent requirements of the user could be satisfied when browsing panoramic images and the utility of panoramic images are enhanced.

### CROSS REFERENCE

The application is a U.S. continuation application under 35 U.S.C. §111(a) claiming priority under 35 U.S.C. §§120 and 365(c) to International Application No. PCT/CN2014/070292 filed Jan. 8, 2014, which claims the priority benefit of CN patent application serial No. 201310162560.2, titled “method and apparatus of retrieving information” and filed on May 3, 2013, the contents of which are incorporated by reference herein in their entirety for all intended purposes.

### TECHNICAL FIELD

The present invention relates to computer technology, and more particularly to a method and apparatus of retrieving information.

### BACKGROUND

Panoramic images are large viewing angle images that are stitched by a plurality of photos, or taken by wide-angle lens, fisheye lens, or normal lens. Panoramic images can show details of the surrounding environment as much as possible using paintings, photos, videos, and 3D models. Especially in street view, which is an implement of panoramic images technique, the user could get an immersed sense at each scene.

The street view is a new form of electronic maps, and is currently being popularized massively. Different from traditional electronic maps, the user can get a visual panoramic view when surfing in the street view, so the street view can show more information, such as the surrounding environments of unfamiliar places, the exact location of the bus stations, and etc. Thus, the street view brings not only a better experience but also more expectations to the user.

As carriers of information, panoramic images in the street view include many specific objects that the user is interested in. For example, the user may want to know the brand of a racing car shown in the panoramic image when browsing the panoramic images in the street view. For another example, the user feels good about the view of a scenic spot in the panoramic images, and he may want to know the bus lines around the scenic spot. However, the existing street view cannot provide further information about the specific objects in the panoramic images, and thus cannot mine the latent demands of the user, and this limits the performance of the panoramic images.

### SUMMARY

This disclosure provides a method and an apparatus of retrieving information. The method and apparatus can solve the problem that the street view cannot provide potentially required information to the user.

In one embodiment, a method of retrieving information includes the following steps: receiving position information of interest points selected by users in a panoramic image; according to the position information of interest points, getting a boundary of a searching object in the panoramic image; according to the boundary of the searching object in the panoramic image, getting a picture of the searching object; sending the picture of the searching object to a backend server and letting the backend server search for the picture; receiving a searching result about the searching object from the backend server; extracting relevant information about the searching object from the searching result; and showing the relevant information.

In another embodiment, an apparatus of retrieving information includes an receiving module, a boundary extracting module, a image extracting module, a sending module, a searching result receiving module, an information extracting module, and a displaying module, stored in the memory and configured for execution by the one or more processors. The receiving module is configured for receiving position information of interest points selected by users in a panoramic image; the boundary extracting module is configured for getting a boundary of a searching object in the panoramic image according to the position information of interest points; the image extracting module is configured for getting a picture of the searching object according to the boundary of the searching object in the panoramic image; the sending module is configured for sending the picture of the searching object to a backend server and letting the backend server search for the picture; the searching result receiving module is configured for receiving a searching result about the searching object from the backend server; the information extracting module is configured for extracting relevant information about the searching object from the searching result; and the displaying module is configured for showing the relevant information.

In a third embodiment, a client includes: memory, one or more processors, and one or more modules stored in the memory and configured for execution by the one or more processors, the one or more modules includes the following instructions: to receive position information of interest points selected by users in a panoramic image; to get a boundary of a searching object in the panoramic image according to the position information of interest points; to get a picture of the searching object according to the boundary of the searching object in the panoramic image; to send the picture of the searching object to a backend server and to let the backend server search for the picture; to receive a searching result about the searching object from the backend server; to extract relevant information about the searching object from the searching result; and to show the relevant information.

### BRIEF DESCRIPTION OF THE DRAWINGS

To illustrate the technical solution according to embodiments of the present invention more clearly, drawings to be used in the description of the embodiments are described in brief as follows. However, the drawings described herein are for illustrative purposes only of selected embodiments and not all possible implementations, and are not intended to limit the scope of the present disclosure. Corresponding reference numerals indicate corresponding parts throughout the several views of the drawings.

FIG. 1 illustrates a runtime environment according to some embodiments.

FIG. 2 is a block diagram illustrating a client according to an embodiment.

FIG. 3 is a flow chart of a method of retrieving information according to an embodiment.

FIG. 4 is another flow chart of a method of retrieving information according to an embodiment.

FIG. 5 is a block diagram of an apparatus of retrieving information according to an embodiment.

FIG. 6 is another block diagram of an apparatus of retrieving information according to an embodiment.

FIG. 7 is a schematic view illustrating the positions of the interest points on the panoramic image with an embodiment.

### PREFERRED EMBODIMENTS OF THE PRESENT INVENTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments.

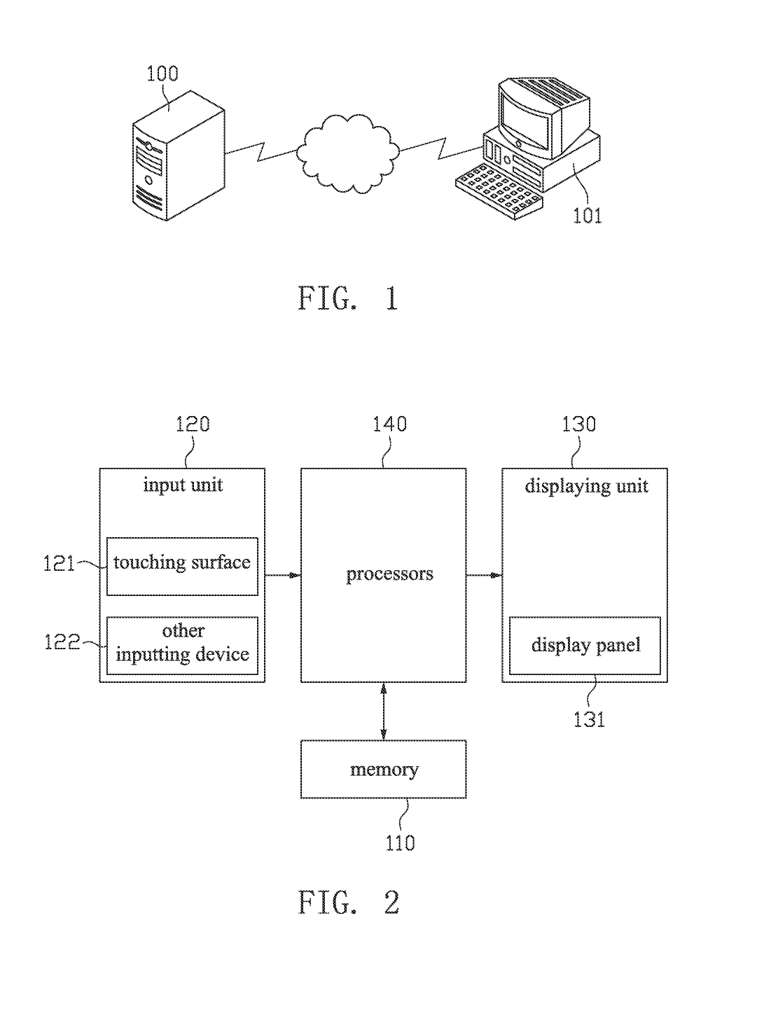

FIG. 1 illustrates a runtime environment according to some embodiments. A client 101 is connected to a server 100 via a network such as internet or mobile communication network. Examples of the client 101 includes, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smartphone (including, but not limited to, an Apple iPhone, a Windows Phone and other smartphones running Windows Mobile or Pocket PC operating systems, and smartphones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, all of which are well known to those skilled in the art.

FIG. 2 illustrates the client 101, according to some embodiments of the invention. The client 101 includes one or more memories 110, an input unit 120, a display unit 130 and one or more processors 140. It should be appreciated that the client 101 is only one example, and the client 101 may have more or fewer components than shown, or a different configuration of components. The various components shown in FIG. 2 may be implemented in hardware, software or a combination of both of hardware and software, including one or more signal processing and/or application specific integrated circuits.

The memory 110 can be used to store software programs and modules, the application is run and the data is processed by the processors 140 according to the software programs and modules stored in the memory 110. The memory 110 may be high speed random access memory or non-volatile memory, such as one or more magnetic disk storage devices, flash memory devices, or other non-volatile solid state memory devices.

The input unit 120 can be used to receive digital or character information, and to produce input signals according to the keyboard, mouse, trackball, and etc. The input unit 120 may include a touching surface 121 and other inputting device 122. The touching surface 121 may also be called as touch screen or touchpad. The touching surface 121 can collect the information of touching operations on it or nearby it. The other inputting device 122 includes one or more of, but are not limited to, a keyboard, function buttons (such as a volume control button, a switch button, and etc.), trackball, mouse, operating lever, etc.

The display unit 130 can be used to display the information. The display unit 130 may include a display panel 131. The display panel 131 may be a LCD (liquid crystal display), OLED (organic light-emitting diode), etc. Further, the touching surface 121 may be covered on the display panel 131, and when touching operations on the display panel 131 is collected by the touching surface 121, the related information is then sent to the processors 140 for determining the type of the touching event. Then the processors 140 output processing results according to the type of the touching event. In the FIG. 2, the display panel 131 and the touching surface 121 are two separate parts, however in some other embodiments, the display panel 131 and the touching surface 121 can be integrated in one part.

The processors 140 are the control center of the client 101. Each part of the client 101 is connected to the processors 140 by all sorts of interface and wiring. When the software programs and modules stored in the memory 110 are executed, and the data stored in the memory 110 is processed, all the functions of the client are realized and all data is processed by the processors 140.

In this disclosure, image segmentation is a technique and process that is applied to divide an image into several areas having distinctive features, and then extract interested objects in the image. The segmentation process could ascertain the interest points in the images and get rid of the interference factors.

In this disclosure, the edge examination technology plays an important role in the application such as computer vision and image analysis. Edge examination is an important part of the image analysis and recognition, and this is because the edges of the divided areas contain important information for image recognition. Thus, edge examination becomes the main method of extracting features in image analysis and pattern recognition. The edges refers to a set of pixels around which the gray levels change sharply and form a step-like or a roof-like distribution, they exist between the object and the background, or between one object and another object, or between an area and another area, or between an image primitive and another image primitive. Therefore, the edges are important characteristics that are used to perform image segmentation, and also are an important information source of textural features and a basis of shape features. The extraction of textural features and the shape features of images are often based on image segmentation. The extraction of the edges in images is also a basis of image matching, this is because the edges are signs of positions, but are not sensitive to the change of gray levels, and can be used as feature points for image matching

An exemplary embodiment of the present invention provides a method of retrieving information; and the method can be performed by the client shown in FIG. 2. The method is configured for displaying the information meeting the latent demands of the user according to the operations on the panoramic images.

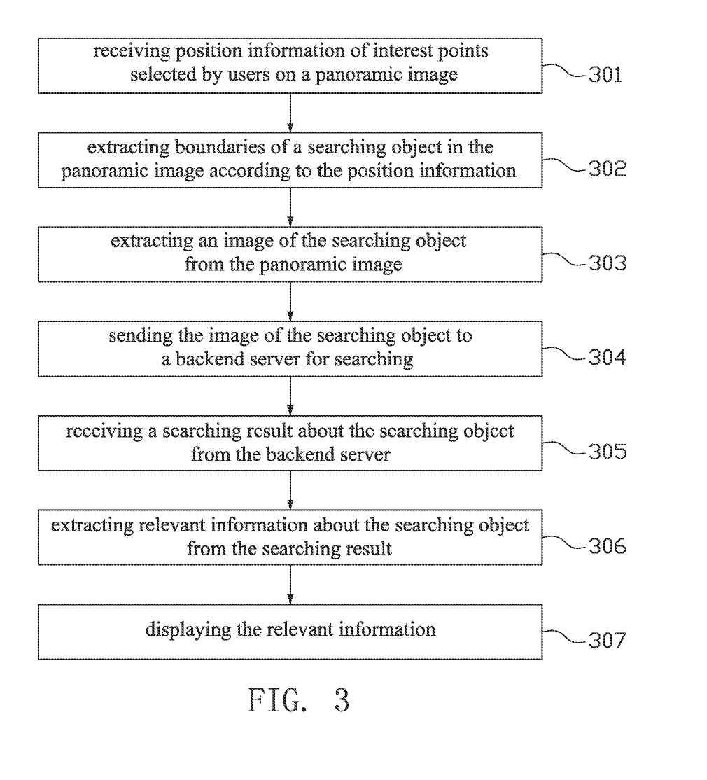

FIG. 3 is a flow chart illustrating a method of retrieving information according to an embodiment. Referring to FIG. 3, the method includes the following steps.

Step 301, receiving position information of interest points selected by users on a panoramic image;

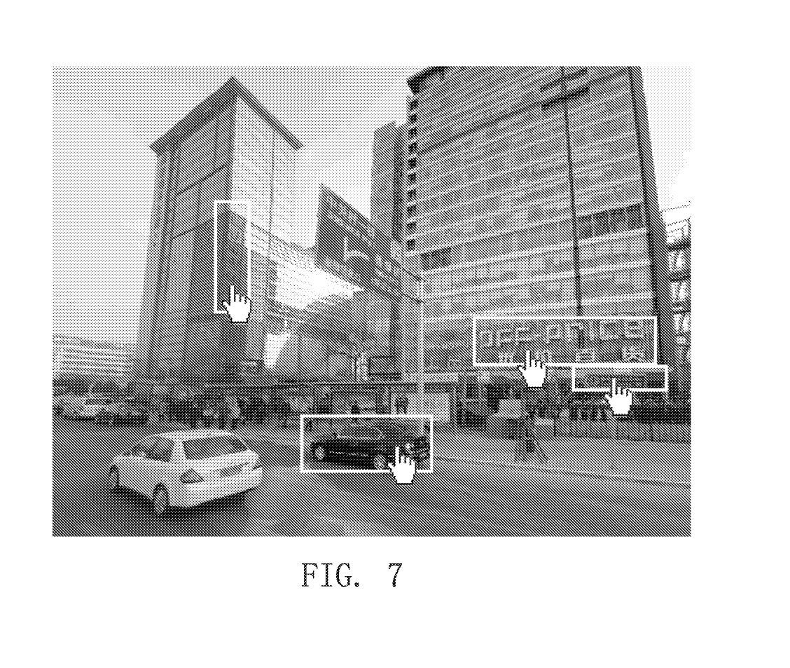

For example, there is a panoramic image application installed in the client. The application can be a native application or a web application. Native application means that the application is separately run on the operating system, while web application means that the application is run on a browser. The application provides a panoramic image browsing interface to the user, and the user could browse the panoramic images in the interface. If the user sees an interesting target, such as a racing car or a building, the user might want to know further information of the target. Then the user could select the target on the panoramic image using a manner such as clicking, box selecting, and etc. Referring to FIG. 7, which is a schematic view of selecting interest points on the panoramic image according to an embodiment. In FIG. 7, a rectangular area corresponding to the hand pointer is the interest point selected by the user.

The position of the interest points is the position where the user operation occurs, and the position of the user operation, for example, coordinates of the clicking operations, coordinates of vertex points of the rectangular selection area, and etc., can be detected by the browsing interface provided by the client.

Step 302, according to the position information of the interest points, extracting boundaries of a searching object in the panoramic image;

The user operations such as clicking and selecting on the panoramic image usually can just point out an approximate position of the searching object, and cannot cover the searching object entirely. The position of the interest points is usually within the searching object, or overlaps with a part of the searching object. For example, the searching object may be a building and the user just clicks on a point of the building on the panoramic image or selects a part of the building on the panoramic image. The rectangular selection area may be bigger than the searching object. In this manner, there is useless information contained in the selection area. The searching object should also be extracted exactly. In summary, the searching object should be extracted after predetermined user operations are detected on the panoramic image browsing interface. Therefore, the boundaries of the searching object should be extracted from the panoramic image. It is to be noted that the boundaries of the searching object in the panoramic image can be extracted by the image processing technology such as the image segmentation, the edge examination and so on.

Step 303, according to the boundaries of the searching object in the panoramic image, extracting an image of the searching object;

It is to be noted that the image of the searching object are all portions of the panoramic image that are included within the boundaries.

Step 304, sending the image of the searching object to a backend server for searching;

The backend server can search the image of the searching object using an existing image search engine. The backend server also includes a database, and search the image of the searching object in the database. The backend server obtains images similar or relevant to the image of the searching object by searching the database, then get relevant information about the searching object. For example, assuming that the searching object is a racing car, the relevant information about the racing car may include the brand of the racing car, driving parameters, size, the contact information of the supplier, and etc.

Step 305, receiving a searching result about the searching object from the backend server.

As described above, after obtaining the relevant information about the searching object, the backend server sends searching result the client. The searching result at least includes the relevant information obtained in the step 304. In one embodiment, the searching result is sent according to a request from the client. In another embodiment, the searching result is put by the backend server to the client actively. Accordingly, the client receives the searching result form the backend server.

Step 306, extracting the relevant information about the searching object from the searching result.

For example, the searching result may in a format of XML (extensible markup language) file, or JSON (javascript object notation) file. After receiving the searching result, the client parses the received file to extract the relevant information.

Step 307, displaying the relevant information of the searching object. If there is only a little relevant information of the searching object, the relevant information can be displayed the browsing interface of the panoramic image directly in the form of a pop-up window. If there is too much relevant information and is not suitable to display it on the pop-up window, the relevant information can be displayed on a separate page. The separate page, for example, means a new tab page of a browser, or a new window in other applications.

According to the above method, searching object can be ascertained from user operations on panoramic images. Then, relevant information of the searching object can be searched and displayed to the user. The method mines the potential information hidden underneath the panoramic images. Accordingly, latent requirements of the user could be satisfied when browsing panoramic images and the utility of panoramic images are enhanced.

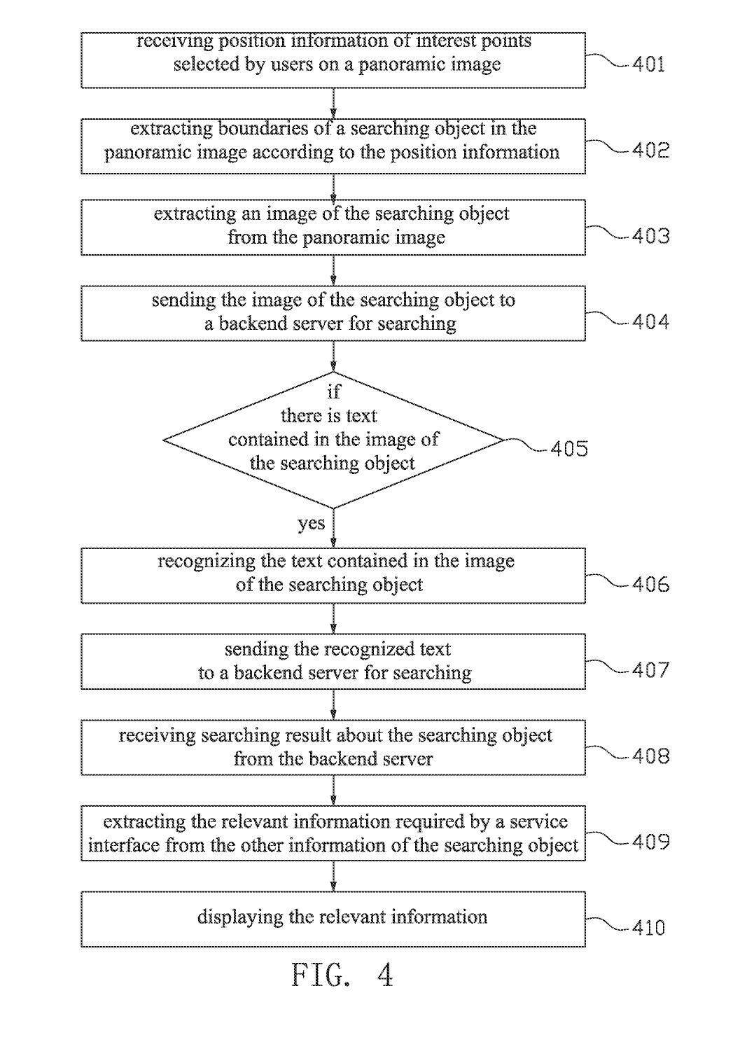

FIG. 4 illustrates a method of retrieving information according to another embodiment. The method can be performed by the client shown in FIG. 2.

The method shown in FIG. 4 is partially similar to the method shown in FIG. 3. For example, the method shown in FIG. 4 also includes the steps 301, 302, 303 and 304.

After the step 304, the method shown in FIG. 4 includes the following steps.

Step 405, checking if there is text contained in the image of the searching object; if there is text contained in the image, a step 406 is executed, otherwise, a step 408 is executed.

Step 406, recognizing the text contained in the image of the searching object.

Optical character recognition (OCR) techniques can be used to recognize the text contained in the image. It is to be noted that the OCR is a process of translating shapes to text, and is a very mature technique. All OCR methods can be employed in the present embodiment. In one example, there is an OCR engine installed in the client, and the OCR process is performed on the client locally. In another example, the client submits the image of the searching object to an online OCR engine and receives the recognized text from the online OCR engine.

Step 407, sending the recognized text to a backend server for searching;

By searching the text contained in the image of the searching object, the searching accuracy can be improved. For example, when the searching object is a building, there is always text “XX building” contained in the image of the searching object. For another example, when the searching object is a scenic spot, there is always the text “XX park” contained in the image of the searching object. If only image searching is used, there are unavoidable mistakes while judging similarity of compared images and this is because the image transformation process employed to produce panoramic images. If image searching and text searching are combined, the searching accuracy is necessarily improved.

Step 408, receiving searching result about the searching object from the backend server. The searching result includes a category (or several categories) and feature describing information of the searching object.

If there is text recognized from the image of the searching object, then the searching result returned from the backend server includes a combination of text searching results and image searching results. If there isn't text recognized from the image of the searching object, the searching result only includes the result of image searching.

To recognize the category of the searching object, objects used to appear in panoramic images should be classified at first. Then, a backend database can be created to record features of each category, such as the keywords of a web page, the color of the image, the other features of the image, and etc. The category, for example, includes scenic spots, buildings, shops, restaurants, cars, signs, billboards, place names, clothes, and etc. After performing the text searching and the image searching, searching results of text searching and image searching can be compared with the information stored in the backend database thereby finding out the category of the searching object.

The feature describing information refers to all the relevant information of the searching object except the category. For example, the feature describing information includes but not limited to telephone, address, websites, names, contacts, and etc.

Step 409, according to the category of the searching object, extracting the relevant information required by a service interface from the other information of the searching object.

For objects of different categories, the user usually needs different information. For example, when the user sees a car in the panoramic image, he may want to know the contact information of the supplier. When the user sees a scenic spot in the panoramic image, he may want to know the bus lines around the scenic spot. When the user sees a restaurant in the panoramic image; he may want to know the menu of the restaurant. The service interface refers to an application programming interface configured to be called by other applications or other modules in a same application. According to the parameters provided by the caller, the service interface could provide corresponding information. That is, the provided information can be customized using predetermined parameters. As such, for objects of different categories, personalized information can be obtained by calling the service interface with customized parameters and then be displayed. In addition, it is understood that the displayed information is not limited as the information provided by the service interface. For example, a button tagged “more” can be displayed on an interface for displaying the customized information, and when the button is clicked; all the relevant information of the searching object can be displayed.

Step 410, displaying the relevant information.

According to the above method, searching object can be ascertained from user operations on panoramic images. Then, relevant information of the searching object can be searched and displayed to the user. The method mines the potential information hidden underneath the panoramic images. Accordingly, latent requirements of the user could be satisfied when browsing panoramic images and the utility of panoramic images are enhanced.

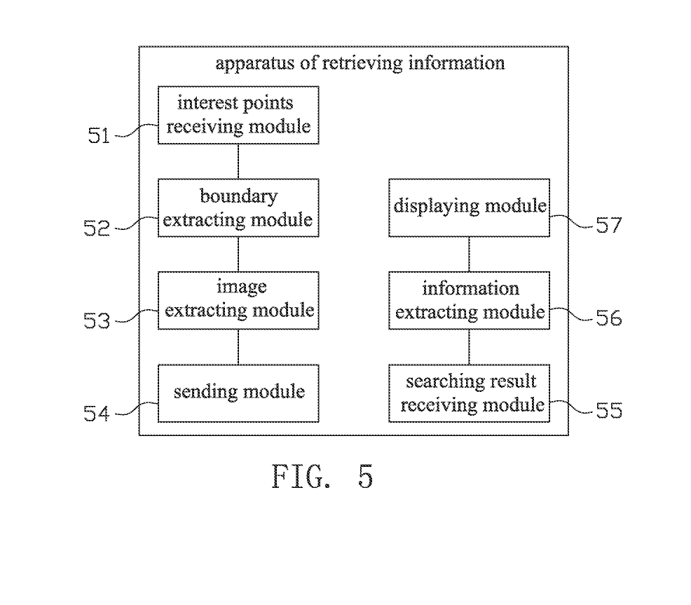

FIG. 5 illustrates an apparatus of retrieving information according to an embodiment. Referring to FIG. 5, the apparatus includes: an interest points receiving module 51, a boundary extracting module 52, an image extracting module 53, a sending module 54, a searching result receiving module 55, an information extracting module 56 and a displaying module 57. The boundary extracting module 52 is coupled to the interest points receiving module 51, the image extracting module 53 is coupled to the boundary extracting module 52, the sending module 54 is coupled to the image extracting module 53, the information extracting module 56 is coupled to the searching result receiving module 55, the displaying module 57 is coupled to the information extracting module 56.

The interest points receiving module 51 is configured for receiving position information of interest points selected by users in a panoramic image. The position of the interest points is the position where the user operation occurs, and the position of the user operation, for example, coordinates of the clicking operations, coordinates of vertex points of the rectangular selection area, and etc., can be detected by the browsing interface provided by the client.

The boundary extracting module 52 is configured for extracting boundaries of a searching object in the panoramic image according to the position information of interest points. The boundary extracting module 52 can extract the boundaries of the searching object in the panoramic image by the image processing technology such as image segmentation, edge examination, and etc.

The image extracting module 53 is configured for extracting an image of the searching object according to the boundaries of the searching object got by the boundary extracting module 52.

The sending module 54 is configured for sending the image of the searching object extracted by the image extracting module 53 to a backend server for searching

The searching result receiving module 55 is configured for receiving a searching result of the searching object from the backend server. The searching result includes at least relevant information of the searching object.

The information extracting module 56 is configured for extracting relevant information about the searching object from the searching result.

The displaying module 57 is configured for displaying the relevant information. If there is only a little relevant information of the searching object, the relevant information can be displayed the browsing interface of the panoramic image directly in the form of a pop-up window. If there is too much relevant information and is not suitable to display it on the pop-up window, the relevant information can be displayed on a separate page. The separate page, for example, means a new tab page of a browser, or a new window in other applications.

According to the above apparatus, searching object can be ascertained from user operations on panoramic images. Then, relevant information of the searching object can be searched and displayed to the user. The method mines the potential information hidden underneath the panoramic images. Accordingly, latent requirements of the user could be satisfied when browsing panoramic images and the utility of panoramic images are enhanced.

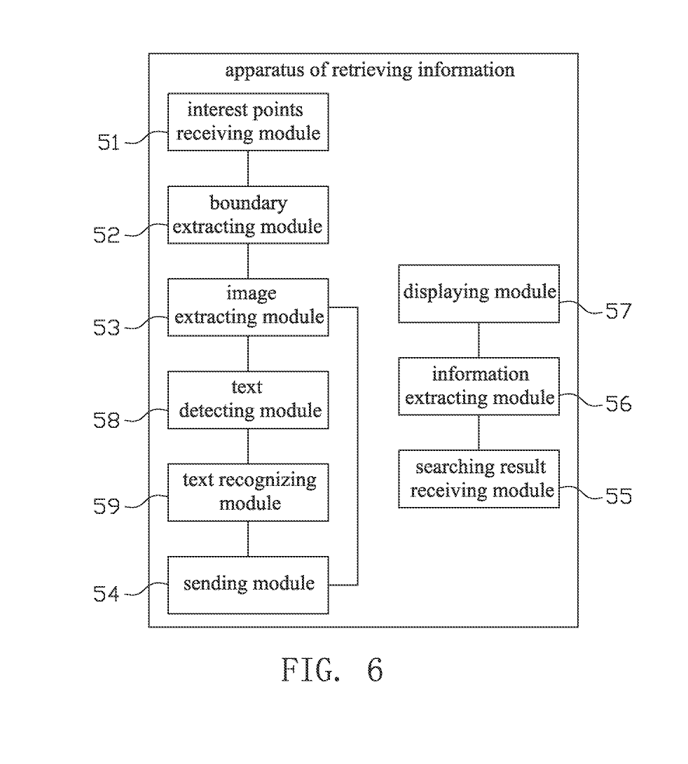

FIG. 6 illustrates an apparatus of retrieving information according to another embodiment. Referring to FIG. 6, the apparatus includes: an interest points receiving module 51, a boundary extracting module 52, an image extracting module 53, a sending module 54, a searching result receiving module 55, an information extracting module 56, a displaying module 57, a text detecting module 58 and a text recognizing module 59. The boundary extracting module 52 is coupled to the interest points receiving module 51, the image extracting module 53 is coupled to the boundary extracting module 52, the sending module 54 is coupled to the image extracting module 53, the information extracting module 56 is coupled to the searching result receiving module 55, the displaying module 57 is coupled to the information extracting module 56, the text detecting module 58 is coupled to the image extracting module 53, the text recognizing module 59 is coupled to the text detecting module 58.

Compare with the apparatus shown in FIG. 5, the apparatus of the present embodiment further includes the text detecting module 58 and the text recognizing module 59. The text detecting module 58 is configured for checking if there is text contained in the image of the searching object. The text recognizing module 59 is configured for recognizing the text contained in the image of the searching object, if the text detecting module 58 has checked that there is text contained in the image. The text recognizing module 59 can use OCR technology to recognize the text contained in the image. If only image searching is used, there are unavoidable mistakes while judging similarity of compared images and this is because the image transformation process employed to produce panoramic images. If image searching and text searching are combined, the searching accuracy is necessarily improved.

Besides, in this embodiment, the searching result received by the searching result receiving module 55 includes a category (or several categories) and feature describing information of the searching object. According to the category of the searching object, the information extracting module 56 extracts the relevant information required by a service interface from the feature describing information of the searching object. The category includes, but not limited to, scenic spots, buildings, shops, restaurants, cars, signs, billboards, place names, clothes, and etc. The feature describing information refers to all the information obtained by the searching process.

For objects of different categories, the user usually needs different information. For example, when the user sees a car in the panoramic image, he may want to know the contact information of the supplier. When the user sees a scenic spot in the panoramic image, he may want to know the bus lines around the scenic spot. When the user sees a restaurant in the panoramic image; he may want to know the menu of the restaurant. The service interface refers to an application programming interface configured to be called by other applications or other modules in a same application. According to the parameters provided by the caller, the service interface could provide corresponding information. That is, the provided information can be customized using predetermined parameters. As such, for objects of different categories, personalized information can be obtained by calling the service interface with customized parameters and then be displayed. The information extracting module 56 in this embodiment can extract the information that the user may need most from the entire feature describing information to improve a browsing efficiency.

According to the above apparatus, searching object can be ascertained from user operations on panoramic images. Then, relevant information of the searching object can be searched and displayed to the user. The method mines the potential information hidden underneath the panoramic images. Accordingly, latent requirements of the user could be satisfied when browsing panoramic images and the utility of panoramic images are enhanced.

All or part of the steps in the above embodiment can be realized by executing relevant process that stored in storage system. The storage system may include memory modules, such as ROM, RAM, and flash memory modules, and mass storages, such as CD-ROM, U-disk, removable hard disk, etc. The storage system is non-transitory computer readable. The storage system may store computer programs for implementing various processes, when executed by processor.

The processor may include any appropriate processor or processors. Further, the processor can include multiple cores for multi-thread or parallel processing.

The contents described above are only preferred embodiments of the present invention, but the scope of the present invention is not limited to the embodiments. Any ordinarily skilled in the art would make any modifications or replacements to the embodiments in the scope of the present invention, and these modifications or replacements should be included in the scope of the present invention. Thus, the scope of the present invention should be subjected to the claims.

### INDUSTRIAL APPLICABILITY AND ADVANTAGEOUS EFFECTS

According to the above embodiments, searching object can be ascertained from user operations on panoramic images. Then, relevant information of the searching object can be searched and displayed to the user. The method mines the potential information hidden underneath the panoramic images. Accordingly, latent requirements of the user could be satisfied when browsing panoramic images and the utility of panoramic images are enhanced.

What is claimed is:

1. A method of retrieving information, comprising:
receiving position information of interest points selected by a user in a panoramic image;
extracting boundaries of a searching object in the panoramic image according to the position information;
extracting an image of the searching object from the panoramic image;
sending the image of the searching object to a backend server for searching;
receiving a searching result about the searching object from the backend server;
extracting relevant information about the searching object from the searching result; and
displaying the relevant information.

2. The method of claim 1, wherein the step of extracting boundaries of a searching object in the panoramic image comprises: extracting the boundaries of the searching object using image processing techniques.

3. The method of claim 1, after the getting an image of the searching object, the method further comprising:
detecting if there is text contained in the image of the searching object;
recognizing the text contained in the image of the searching object if there is text contained in the image of the searching object; and
sending the text to the backend server for searching.

4. The method of claim 3, wherein in the step of recognizing the text contained in the image of the searching object:
the text is recognized using an optical character recognition technique.

5. The method of claim 1, wherein the searching result comprises a category and feature describing information of the searching object; the step of extracting relevant information about the searching object from the searching result comprising: extracting relevant information required by a service interface from the feature describing information of the searching object according to the category of the searching object.

6. A client, comprising:
a memory;
one or more processors; and
one or more modules stored in the memory and configured for execution by the one or more processors, the one or more modules comprising instructions:
to receive position information of interest points selected by a user in a panoramic image;
to extract boundaries of a searching object in the panoramic image according to the position information;
to extract an image of the searching object from the panoramic image;
to send the image of the searching object to a backend server for searching;
to receive a searching result about the searching object from the backend server;
to extract relevant information about the searching object from the searching result; and
to display the relevant information.

7. The client of claim 6, wherein the instruction to extract boundaries of a searching object in the panoramic image according to the position information comprises: instructions to extracting the boundaries of the searching object using image processing techniques.

8. The client of claim 6, the one or more modules further comprising instructions to:
detect if there is text contained in the image of the searching object;
recognize the text contained in the image of the searching object if there is text contained in the image of the searching object; and
send the text to the backend server for searching.

9. The client of claim 8, wherein in the instructions to recognize the text contained in the image of the searching object comprises instructions to:
recognized the text using an optical character recognition technique.

10. The client of claim 6, wherein the searching result comprises a category and feature describing information of the searching object;
the instructions to extract relevant information about the searching object from the searching result comprising instructions to extract relevant information required by a service interface from the feature describing information of the searching object according to the category of the searching object.

11. A computer readable storage medium storing one or more programs, the one or more programs comprising instructions, which when executed by an electronic device, cause the electronic device to perform a method comprising:
receiving position information of interest points selected by a user in a panoramic image;
extracting boundaries of a searching object in the panoramic image according to the position information;
extracting an image of the searching object from the panoramic image;
sending the image of the searching object to a backend server for searching;
receiving a searching result about the searching object from the backend server;
extracting relevant information about the searching object from the searching result; and
displaying the relevant information.

12. The computer readable storage medium of claim 11, wherein the step of extracting boundaries of a searching object in the panoramic image comprises: extracting the boundaries of the searching object using image processing techniques.

13. The computer readable storage medium of claim 11, after the getting an image of the searching object, the method further comprising:
detecting if there is text contained in the image of the searching object;
recognizing the text contained in the image of the searching object if there is text contained in the image of the searching object; and
sending the text to the backend server for searching

14. The computer readable storage medium of claim 13, wherein in the step of recognizing the text contained in the image of the searching object:
the text is recognized using an optical character recognition technique.

15. The computer readable storage medium of claim 11, wherein the searching result comprises a category and feature describing information of the searching object;
the step of extracting relevant information about the searching object from the searching result comprising: extracting relevant information required by a service interface from the feature describing information of the searching object according to the category of the searching object.
